(19) United States
(12) Patent Application Publication
(10) Pub. No.: US 2013/0232204 A1
(43) Pub. Date: Sep. 5, 2013

(54) IDENTIFYING AND PROCESSING PREVIOUSLY SENT AND RECEIVED MESSAGES

(71) Applicants: Jonathan M. Barney, Kingston, NY (US); Gregory J. Fischer, Longmont, CO (US); Michael L. Massimi, South Hamilton, MA (US); Kevin C. McConnell, Austin, TX (US)

(72) Inventors: Jonathan M. Barney, Kingston, NY (US); Gregory J. Fischer, Longmont, CO (US); Michael L. Massimi, South Hamilton, MA (US); Kevin C. McConnell, Austin, TX (US)

(73) Assignee: INTERNATIONAL BUSINESS MACHINES CORPORATION, Armonk, NY (US)

(21) Appl. No.: 13/409,312

(22) Filed: Mar. 1, 2012

(51) Int. Cl. G06F 15/16

(52) U.S. Cl. 709/206

(57) ABSTRACT

Automated response options manage messaging by comparing content of an input message to content saved in a store of previous messages, and to meta data content of each of a plurality of frequently asked question web pages. If the compared content matches to either of the saved content or to the frequently asked question web pages meta data content and the message meets a requirement of a policy rule, a reply message is automatically composed and sent by a processing unit, the reply including the matching content or a link to the matching content if the input message is a newly received message. If the content does not match or the input message does not meet the policy rule requirement, a copy of the message is saved and a user prompted to manually compose and send a reply.

### BACKGROUND

Embodiments of the present invention relate to processes and systems for differentially managing messaging in response to identifying previously sent or received messages.

Communicating through email, text messaging, forums, social networking and other networked and computerized tools and applications may result in an inundation of electronic messages. In some cases, a sender may forget that they have already sent a message to an individual or group in the past and resend it. Duplicate messages may also be sent intentionally, in some cases to make sure the previously sent message has been message received, read or otherwise processed appropriately.

However, duplicate or identical messages, whether from the same or different senders, are often unwelcomed by a receiver. In one aspect, they may require the receiver to unnecessarily duplicate the generation and sending of a previous response. For example, a user responding to queries on a messaging system may answer a question one day, and then find that the same question comes in days later. The user must either retype and send the same answer, perhaps as customized to a different requestor, or use some process to search and retrieve the earlier answer and forward, resend or otherwise reuse the same message or similar answer text.

The prior art provides for defining filters to block unwanted messages that contain certain words or are from specific individuals, or for sorting messages by subject, sender, receiver to find duplicate messages. However, such solutions generally require users to actively review possible duplicate messages to determine whether they may be duplicates, and also to actively select and direct an appropriate search mechanism to find the earlier possible duplicate message. For example, the user must generally provide a search term for a keyword search, and then review a plurality of results to find the earlier message. Such processes are time consuming and inconvenient and may actually require more effort and time to execute than merely retyping and sending a new reply.

### BRIEF SUMMARY

In one embodiment of the present invention, a method for utilizing automated response options to manage messaging includes comparing by a processing unit content of an input message to content saved in a store of previous messages, and to meta data content of each of a plurality of frequently asked question web pages that are accessible to the processing unit via a network connection, in response to the input of the message. If the comparing finds a match of the input message content to either of the content saved in the store of previous messages or to the frequently asked question web pages meta data content, a policy rule is applied to the input message and a reply message automatically composed and sent by the processing unit. The reply includes matching content or a link to matching content if the input message is a newly received message and meets the requirement of the policy rule. The processing unit also automatically completes a composition of the input message by utilizing the matching content or providing the link to the matching content if the input message is a new message under composition by the user and meets the requirement of the policy rule. If the content does not match either the content saved in the store of previous messages or to the frequently asked question web pages meta data content, or if the input message does not meet the requirement of the policy rule, a copy of the message is saved and a user prompted to manually compose and send a reply.

In another embodiment, a method further provides a service for utilizing automated response options to manage messaging by integrating computer-readable program code into a computer system comprising a processing unit, a computer readable memory and a computer readable tangible storage medium. Computer readable program code is embodied on the computer readable tangible storage medium and comprises instructions that, when executed by the processing unit via the computer readable memory, cause the processing unit to compare content of an input message to content saved in a store of previous messages, and to meta data content of each of a plurality of frequently asked question web pages that are accessible to the processing unit via a network connection, in response to an input of the message. If the comparing finds a match of the input message content to either of the content saved in the store of previous messages or to the frequently asked question web pages meta data content, a policy rule is applied to the input message and a reply message automatically composed and sent by the processing unit. The reply includes matching content or a link to matching content if the input message is a newly received message and meets the requirement of the policy rule. The processing unit also automatically completes a composition of the input message by utilizing the matching content or providing the link to the matching content if the input message is a new message under composition by the user and meets the requirement of the policy rule. If the content does not match either the content saved in the store of previous messages or to the frequently asked question web pages meta data content, or if the input message does not meet the requirement of the policy rule, a copy of the message is saved and a user prompted to manually compose and send a reply.

In another embodiment, a system has a processing unit, computer readable memory and a tangible computer-readable storage medium with program instructions, wherein the processing unit, when executing the stored program instructions compares content of an input message to content saved in a store of previous messages, and to meta data content of each of a plurality of frequently asked question web pages that are accessible to the processing unit via a network connection, in response to an input of the message. If the comparing finds a match of the input message content to either of the content saved in the store of previous messages or to the frequently asked question web pages meta data content, a policy rule is applied to the input message and a reply message automatically composed and sent by the processing unit. The reply includes matching content or a link to matching content if the input message is a newly received message and meets the requirement of the policy rule. The processing unit also automatically completes a composition of the input message by utilizing the matching content or providing the link to the matching content if the input message is a new message under composition by the user and meets the requirement of the policy rule. If the content does not match either the content saved in the store of previous messages or to the frequently asked question web pages meta data content, or if the input message does not meet the requirement of the policy rule, a copy of the message is saved and a user prompted to manually compose and send a reply.

In another embodiment, an article of manufacture has a tangible computer-readable storage medium with computer readable program code embodied therewith, the computer readable program code comprising instructions that, when executed by a computer processing unit, cause the computer processing unit to compare content of an input message to content saved in a store of previous messages, and to meta data content of each of a plurality of frequently asked question web pages that are accessible to the processing unit via a network connection, in response to an input of the message. If the comparing finds a match of the input message content to either of the content saved in the store of previous messages or to the frequently asked question web pages meta data content, a policy rule is applied to the input message and a reply message automatically composed and sent by the processing unit. The reply includes matching content or a link to matching content if the input message is a newly received message and meets the requirement of the policy rule. The processing unit also automatically completes a composition of the input message by utilizing the matching content or providing the link to the matching content if the input message is a new message under composition by the user and meets the requirement of the policy rule. If the content does not match either the content saved in the store of previous messages or to the frequently asked question web pages meta data content, or if the input message does not meet the requirement of the policy rule, a copy of the message is saved and a user prompted to manually compose and send a reply.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a block diagram illustration of an embodiment of the present invention.

FIG. 2 is a block diagram illustration of an embodiment of the present invention that identifies previously sent messages or like content within a message created by a user while the user is creating the new message.

FIG. 3 is a block diagram illustration of an embodiment of the present invention that helps guide a user in the construction of a new message based on intersecting with other data sources as the message is developed.

FIG. 4 is a block diagram illustration of an embodiment of the present invention that analyzes newly received messages to identify previously received messages or like content in order to utilize automated response options to handle repetitive incoming messages.

FIG. 5 is a block diagram illustration of a computerized implementation of an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

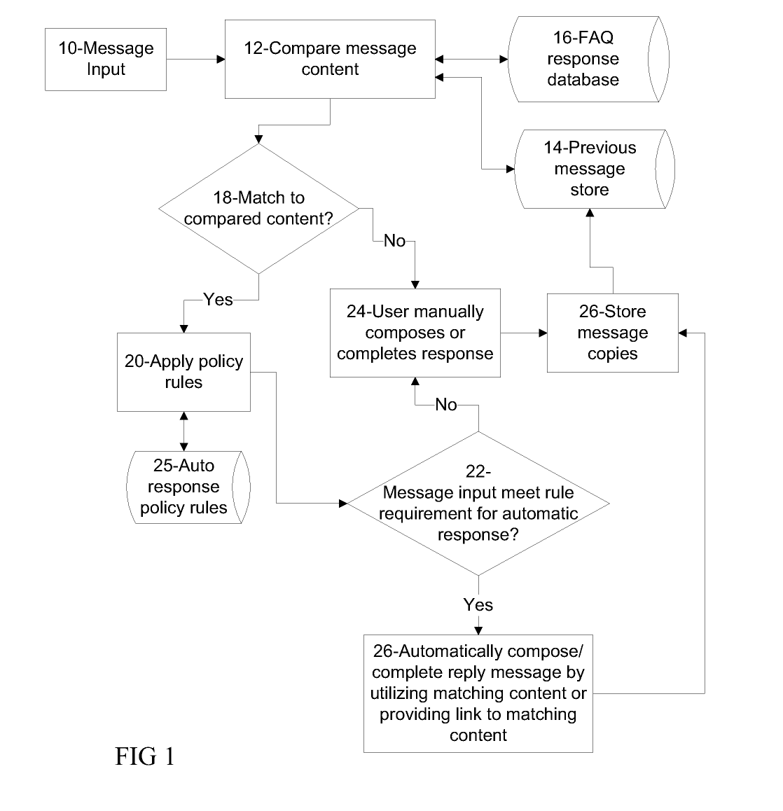

FIG. 1 illustrates an embodiment of the present invention that utilizes automated response options to manage messaging. In response to an input of a message at 10, content of the input message is compared at 12 to content saved in a store of previous messages 14, and to meta data content of each of a plurality of Frequently Asked Question (FAQ) web pages that are accessible via a network connection at 16. If the comparing finds a match of the input message content to either of the content saved in the store of previous messages or to the frequently asked question web pages meta data content, then a policy rule is applied to the input message at 20.

If the input message meets a requirement of the policy rule at 22, then a processing unit automatically composes and sends a reply message comprising the matching content or a link to matching content (if the message input 10 is a newly received message); completes a composition of the input message by utilizing the matching content or providing the link to the matching content, and sends the automatically completed message (if the message input 10 is a new message under composition by the user); or otherwise satisfies the input message with use of the matching content. If a message is sent at 22, the sent message is saved to the previous message store 14 at 26.

However, if the comparing at 18 does not find a match of the input message content to either of the content saved in the store of previous messages or to the frequently asked question web pages meta data content, or if the input message does not meet the requirement of the policy rule at 22, then the user is prompted to manually compose and send a reply message (if the message input 10 is the newly received message), or to manually complete the composition of the input message and to send the manually completed message (if the input message is the new message under composition by the user). Copies of the messages are saved to the previous message store at 26

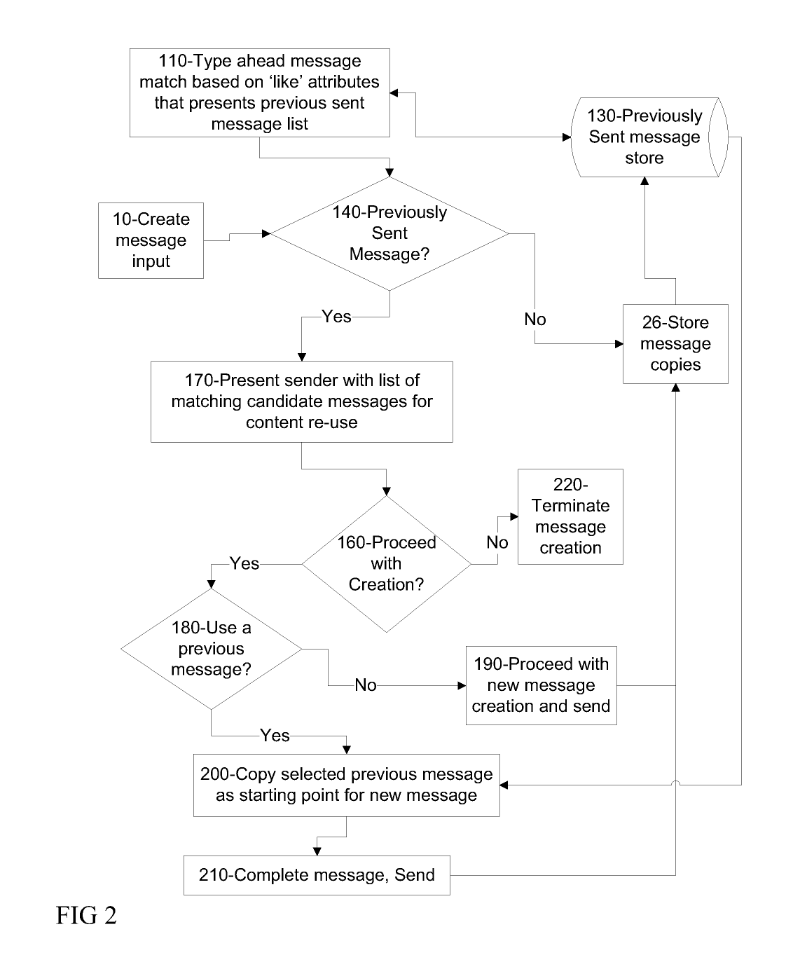

FIG. 2 illustrates another embodiment of the present invention that identifies previously sent messages or like content within a message created by a user while the user is creating the new message. In one aspect, the embodiment is a variation of concepts of FIG. 1 and prevents the completion and generation and sending of a new message if it is repetitive to a previously sent message or to another prior content source. Thus, the message input 10 in FIG. 2 comprises inputs from a user beginning to create a new message or to forward another previous message. As the body of the new message is composed, a type-ahead match is performed at 110 for the new message content as it is entered against content contained in a previously-sent message store 130.

If a positive match is achieved on one or more of the previously sent messages at 140, then at 170 the user is presented with a list of full and partial match candidates to choose from. The new message composer may thereby determine if he/she still wishes to proceed with composing and sending the new message at 160 in view of the search results. If not, for example if one of the match candidates appears to have fully satisfied a request from a message sender that the current message is being composed to satisfy, wherein no additional message is believed necessary, then the user may decide to terminate the new message creation at 160 and 220 based on said previously sent message match results.

Otherwise, after reviewing the matching candidate list, the user may decide to proceed with the new message creation at 160. The user may elect at 180 to use all or part of one or more of the match candidate list messages presented at 170 in substitution of the presently created message, thus at 200 using part or all of a previous message as a starting draft or template for the current message, or copy some or all of previous message content into the new message, revising either as needed. At 210 the new message using the match candidate list content is completed and sent.

The user may also instead elect to create and send all new message content at 190. In one aspect, the new message may be drafted in response to the review of the match candidate list results presented at 170, the user intentionally revising the current message to avoid duplicating the earlier content, or to create new content that complements, amplifies or otherwise extends the presented match candidate list content.

Copies of messages sent are stored in the previous message store 130 at 26 for use in matching to future messages according to the present embodiment. This includes each new message composed and sent at 210 using the match candidate list content; at 190 comprising entirely new (non-matching) content; or sent messages comprising content that did not match any of the previous messages via the type-ahead matching process at 140.

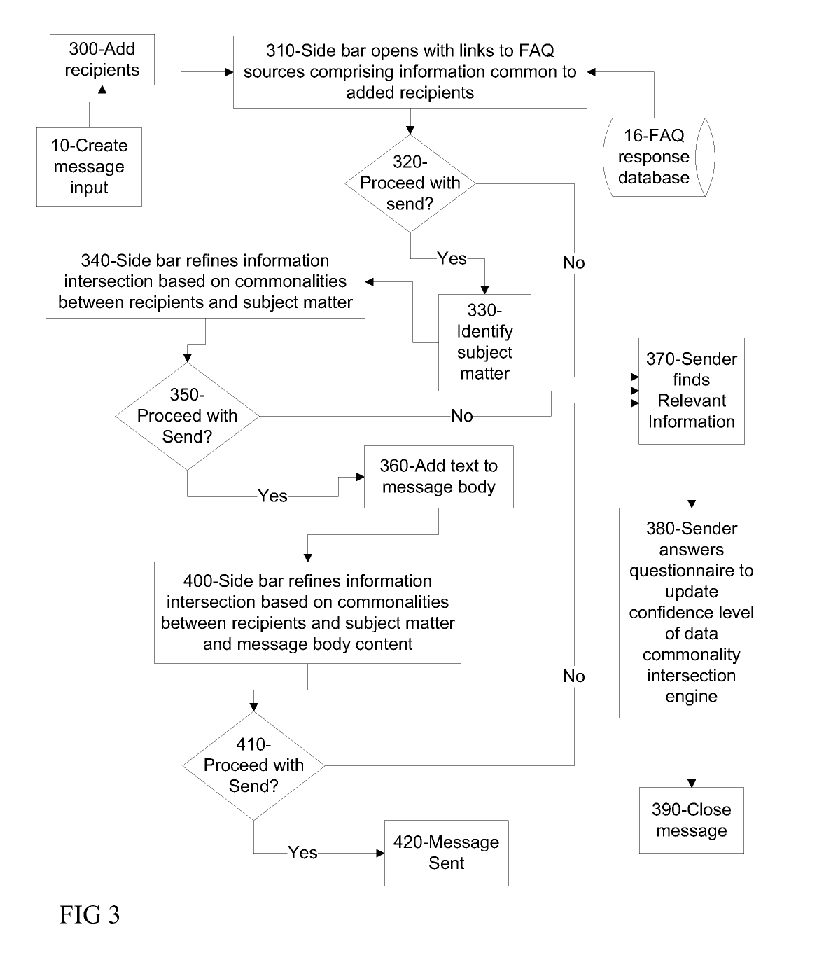

FIG. 3 illustrates an embodiment of the present invention that helps guide a user in the construction of a new message based on intersecting with other FAQ data sources 16 in addition to the previously sent message store 130 (FIG. 2) as the message is developed. In one aspect, the guidance may provide information sufficient to achieve circumvention of the necessity of sending the message altogether. Thus, wherein the message input 10 is creation of the new message by a user in FIG. 3, at 300 the user (Sender) designates or adds recipients to the message.

In response to the recipients added/designated at 300, at 310 a side bar or other graphical user interface (GUI) window or information presentment opens populated with FAQ content 16, which may comprise web pages, wiki pages featuring content about or created by one or more of the added message recipients, or other informational sources tagged with or otherwise associated with or relevant to the added recipients. More particularly, meta data associated with these other sources 16 is analyzed for intersections of their information based on common recipient data or meta data.

The sources presented in the sidebar provide information sources that may satisfy the needs of the user instigating the new message creation. For example, an added recipient may be an administrator of a networked resource, and the purpose of the message under composition by the user at 300 is to inquire as to how to reset a password. The sidebar at 310 may present a FAQ page accessible at 16 for this administrator recipient (found through a meta data search) that provides instructions on password resetting. Accordingly, at 320 the user may choose to discontinue the message creation at 370 and instead utilize the presented FAQ or other relevant side bar information source. In the present embodiment, the user is also presented with a questionnaire at 380 to improve future searches based on confidence of intersection of common information presented in pre-send informational sidebar, and the message is closed at 390. The confidence level of the Sidebar information may thus be improved based on analytics on common information from one or more of recipients, subject and message body text attributes of the nascent message and intersecting data sources.

If instead the user decides to continue on with creating the new message at 320, then at 330 the user identifies the subject matter of the new message, for example by entering text into a message subject heading, or supplying tags or other keyword labels to the message. The identified subject matter is analyzed for commonalities with and between the recipients and the sidebar information refined at 340. For example, new intersecting data options may be presented as newly relevant, or some items may be deleted as no longer relevant, with respect to the added recipients in view of the subject indicator information.

At 350 the user may again choose to discontinue the message creation at 370 based on instead using the revised, relevant sidebar information, or to proceed on with the message creation at 360 wherein the user adds text to message body. The added message body text is analyzed for commonalities with and between the subject matter, the recipients and the sidebar information, resulting in a further responsive refinement to the sidebar information at 400. At 410 the user may again choose to discontinue the message creation at 370 based on instead using the further revised, relevant sidebar information, or to not utilize the relevant information presented in the sidebar but instead proceed on to finish and send the newly created message creation at 420.

It will be understood that the above example is not limiting as to the order of the information used to create or refine the sidebar information in embodiments of the present invention at 310, 340 or 400. For example, the initial sidebar creation may instead occur in response to subject matter or message body text inputs, with subsequent refinements triggered by the input of others of the added recipient, subject matter and body text data. Creation or refinement of the side bar information at any of 310, 340 and 400 may also occur simultaneously with another, and no preferential order is required to practice embodiments of the present invention.

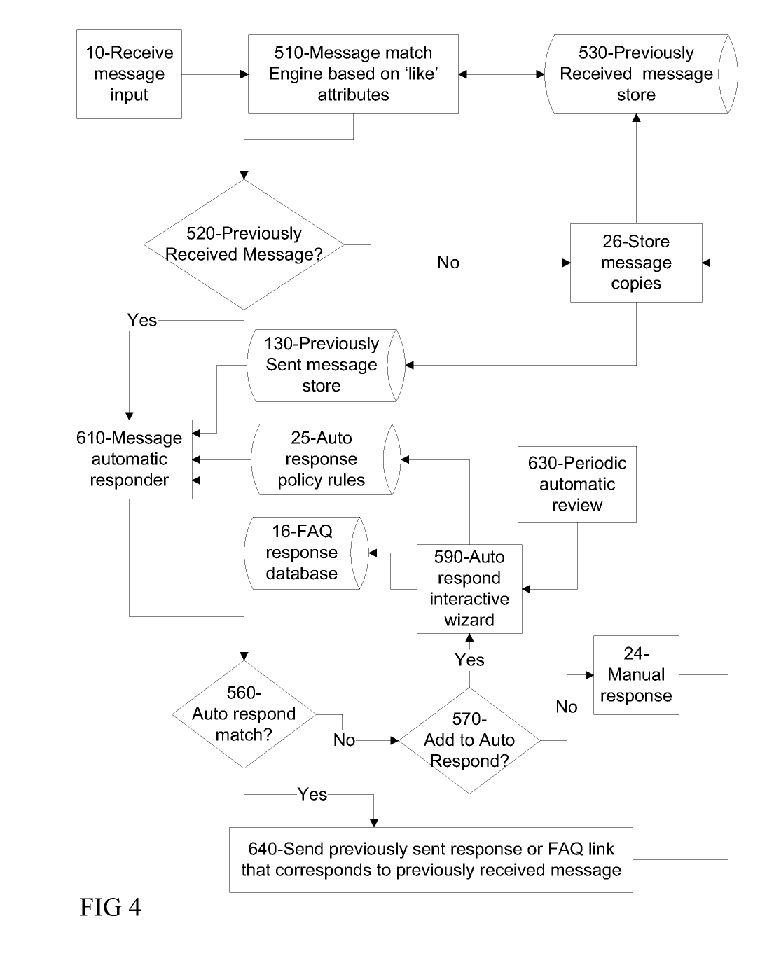

FIG. 4 illustrates an embodiment of the present invention that analyzes newly received messages to identify previously received messages or like content in order to utilize automated response options to handle repetitive incoming messages. Thus, wherein the message input 10 is a new message received by a user's message receiver device or application in FIG. 4, a like-match comparison is performed at 510 against message content saved in a previously received message store 530. If no match is determined at 520, then a copy of the newly received message is saved at 26 into the previous message store 530 for future use.

If instead at 520 a successful previously-received message match occurs, then one or more message automatic responder processes at 610 provide analytics as a function of data within the previously-sent message store 130, the policy rules store 25 (in this embodiment, comprising a plurality of auto-responder rules) and the FAQ database 16, to determine and produce an intelligent reply message response that may be automatically sent back to the message sender.

In some cases, the automatic process at 610 may indicate that the new message should be auto-deleted and no response required or advised, for example due to a relation to multiple previous duplicate messages sent and received with respect to the sender indicating that queries of the sender are already reasonably and fully satisfied, or where the previous sender and message content are associated with designated auto-delete content or a junk mail rule. Other illustrative but not exhaustive examples of the auto-responder policy rules stored at 25 include:
a. Source authentication parameters. These may indicate appropriate responses based upon identify, title, organization or other source information relevant to the sender. Thus, in response to identifying that the sender is a supervisor or important customer a policy rule may indicate that a specialized automatic response, or that no automated response but instead a new, personalized message, should be generated.
b. Message content keywords. For example, the presence of keywords or phrases such as “login” or “password reset instructions” may indicate certain automated or otherwise pre-composed responses are appropriate to send in response.
c. Operational mode settings. Different automated responses may be indicated based on a temporal status of the recipient, such as in or out of office, on vacation, time of message receipt during workday or weekend or after business hours, etc.

Accordingly, the process may at 560 find a previously sent response within the store 130, or a FAQ or other non-message resource within the FAQ response database 16, that matches the received message in view of the auto-response policy rules 25 and automatically send the matching previously-sent message or FAQ source link or other citation at 640 in response to the current message. A copy of the said reply message is saved at 26 into the previous message store 530 for future use.

The message reply sent at 640 may be automatically selected or composed and sent without requiring active involvement of the user receiving the newly received message, or otherwise interrupting the receiver of the message. In some embodiments, the automatic response may comprise an appropriate pre-fixed message text informing the message sender that the response is automated: for example, “John's FAQ is auto-responding on his behalf, does the below message answer your enquiry? If not, simply reply to this message with no added text and John will personally address your message ASAP”. If the auto-response does satisfy the originator (no reply is received in response to said notification text), then no further action is required by the user. Thus, the automated process has handled the incoming message input 10 without requiring the time or attention of the user, who remains more productive with less message interruptions than his prior art counterparts without the benefit of the present embodiment.

However, if at 560 no appropriate matching sent message or FAQ link is found in the stores 130 and 16, or the message does not otherwise qualify for an automatic response as a function of the analytics auto-response rules 25, then the recipient user is prompted at 570 with an opportunity to create new or revised auto-response rules or FAQ content for use in automated reply to the current and future received messages at subsequent iterations of the process at 610. Thus, the user may elect at 570 to use an interactive program dialog at 590 to revise existing or create new policy rules 25 or FAQ content 16 for reapplication in another, subsequent iteration at 610 to the received message. Said revisions or new content may thus enable sending at 640 of a satisfactory matching message stored at 130 in reply to this message, and to other similar messages in subsequent iterations.

At 570 the user may also elect to respond to the message in a manual fashion at 24, for example by composing and sending a new message. At 26 copies of the replies sent, whether manually at 24 or automatically generated at 640, are saved to the previously sent messages store 130, and a copy of the received message is stored in the previously received store 530; in some embodiments, the storing operations also store data associating the message received at 10 with the replies eventually generated and sent at 24 or 640.

At 630 a periodic review of the of FAQ response database 16 or the auto-response rules 25 is triggered via the interactive wizard at 590 to ensure relevancy of their respective content, wherein stale content is identified based on usage metrics and presented to the user, who may responsively delete or adjust the stored FAQ content or associated policy rules accordingly.

Though the embodiments of FIGS. 1 through 4 are linked in the present discussion (for example, sharing common input elements 10 and some other various elements), such linking is optional. Each of the embodiments may be practiced together, in parallel or in series, or they may be implemented separately or independently from each other.

Embodiments of the present invention are useful in processing and managing messages sent or received by a user via email, text messaging, forum, social networking and other networked and computerized messaging tools and applications. Recognizing and handling duplicative messages through automated processes on response on behalf of a user eliminates a percentage of the total messages that one must process, and also helps to remove duplication and repetitive manual steps in handling message workloads, thereby making the user more productive and efficient.

Though it is known to search prior messages for common senders, recipients, subjects and text items, such prior art techniques do not extend to finding items or sources outside of messaging stores, such as the unassociated FAQ web pages accessible at 16. FAQ pages may directly provide information sought by a message sender, or otherwise be useful in directing users to other content that will satisfy queries within their messages. This may be more likely with respect to questions and answers that are repetitively asked and answered over time and thus generate copious or highly refined and useful response data.

Recognizing the relation of a new message to other non-message content as well as to previous messages may be accomplished through a variety of techniques. Some embodiments generate and store a digest or index of text from all outgoing and received messages and FAQ sources (for example, in the stores 130, 530, or 16 discussed above), and compare the digest or index to new messages received or being composed for a match or other relevancy indication and process accordingly.

Embodiments of the present invention may also use pattern matching algorithms to find relevant message or other resources that may not directly match through text searching and indexing, but wherein overall subject matter or concepts may be “like” or otherwise similar enough to satisfy a request of the sender or composer of the message. For example, during the composition of new message subject areas, issues or other abstract overall meanings may be inferred from key words in the subject and main body text portions of the message on a continual (real-time) basis, and these inferred concepts may be matched against previously similar concepts saved to metadata for items in message, FAQ and other content stores, resulting in the sidebar recommendations at 310, 340 or 400 of FIG. 3. Similar processes may also be implemented at 10 and 110 of FIG. 2, and at 510 or 610 of FIG. 4.

Content matching as implemented in embodiments of the present invention may provide dynamic form letter recognition engines that analyze messages as they are composed. Such engines may recognize in real-time that a message has already been sent, or that a same or similar message has been previously sent, and provide suggestions to use the previous message or portions of it, while the user is in the process of typing or otherwise composing the message. Thus, rather than composing the remainder of a message, the user may quickly confirm a selection of the substitute message or selection there from, enabling the user to more quickly finish and send a reply message.

Some prior art teaches identifying and indexing portions of previously sent messages to create templates useful in future document composition. For example, U.S. Patent Publication 2007/0094329 teaches the use of templates selected from previous messages with variable fields for population with current values, such as “sell X shares of stock YZ,” with variables for the number of shares (X) and the symbol of the stock (YZ). Though the use of templates and other pre-determined text blocks is useful in document composition, such templates are not capable of automatically finding and sending matching, prior responses, but instead require inputs or other active, direct customization by the user for each message.

Relationships between parties within an organization may also be useful in determining appropriate message recipients, such as taught by “An Efficient Information Sharing Approach For Large Scale Multi-Agent Team” by Xu et al (published in 2008 11th International Conference on Information Fusion (FUSION 2008), 8 pp., IEEE, Piscataway, N.J., USA). However, such teachings do not use previous message sender or recipient identities to find other non-messaging information resources linked to those senders or recipients that may entirely substitute for a potential reply message, as may be accomplished by embodiments of the present invention.

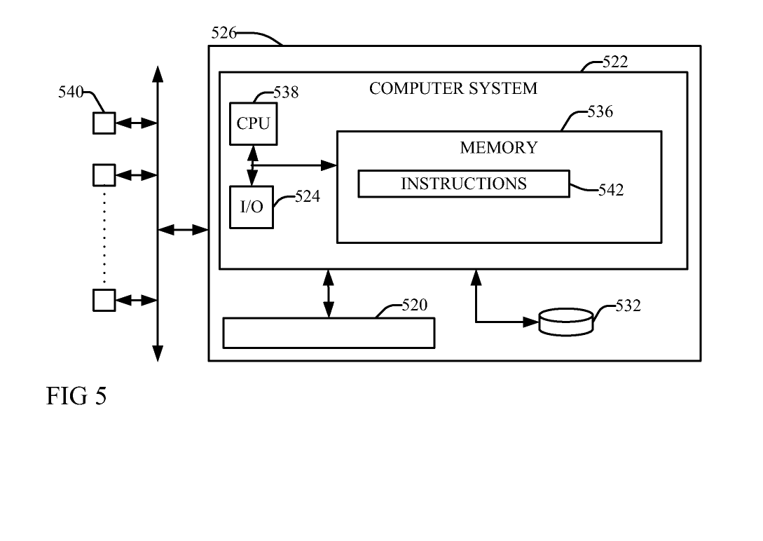

Referring now to FIG. 5, an exemplary computerized implementation of an embodiment of the present invention includes a computer system or other programmable device 522 in communication with network data sources 540 that identifies like content within previously sent messages or other intersecting data sources with respect to a message created by a user, and/or analyzes newly received messages to identify like content in previously received messages or other intersecting data sources to utilize automated response options to handle repetitive incoming messages. Instructions 542 reside within computer readable code in a computer readable memory 536, or in a computer readable storage system 532, or other tangible computer readable storage medium that is accessed through a computer network infrastructure 526 by a processing unit (CPU) 538. Thus, the instructions, when implemented by the processing unit (CPU) 538, cause the processing unit (CPU) 538 to perform interactive analysis of data objects within a display as described above with respect to FIGS. 1 through 4.

Embodiments of the present invention may also perform process steps of the invention on a subscription, advertising, and/or fee basis. That is, a service provider could offer to integrate computer-readable program code into the computer system 522 to enable the computer system 522 to identify like content within previously sent messages or other intersecting data sources with respect to a message created by a user, and/or analyze newly received messages to identify like content in previously received messages or other intersecting data sources to utilize automated response options to handle repetitive incoming messages, as described above with respect to FIGS. 1 through 5. The service provider can create, maintain, and support, etc., a computer infrastructure such as the computer system 522, network environment 526, or parts thereof, that perform the process steps of the invention for one or more customers. In return, the service provider can receive payment from the customer(s) under a subscription and/or fee agreement and/or the service provider can receive payment from the sale of advertising content to one or more third parties. Services may comprise one or more of: (1) installing program code on a computing device, such as the computer device 522, from a tangible computer-readable medium device 520 or 532; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the Figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for utilizing automated response options to manage messaging, the method comprising:
in response to an input of a message, comparing by a processing unit content of the input message to content saved in a store of previous messages, and to meta data content of each of a plurality of frequently asked question web pages that are accessible to the processing unit via a network connection;
if the comparing finds a match of the input message content to either of the content saved in the store of previous messages or to the frequently asked question web pages meta data content:
applying a policy rule to the input message;
automatically by the processing unit composing and sending a reply message comprising at least one of the matching content or a link to the matching content, if the input message is a newly received message and meets a requirement of the policy rule; and
automatically by the processing unit completing a composition of the input message by utilizing the matching content or providing the link to the matching content, and sending the automatically completed message, if the input message is a new message under composition by the user and meets the requirement of the policy rule;
if the comparing does not find a match of the input message content to either of the content saved in the store of previous messages or to the frequently asked question web pages meta data content, or if the input message does not meet the requirement of the policy rule:
saving a copy of the input message to the store of previous messages;
prompting a user to manually compose and to send the manually composed reply message if the input message is the newly received message; and
prompting the user to manually complete the composition of the input message and to send the manually completed message if the input message is the new message under composition by the user.

2. The method of claim 1, wherein the message input is the new message under composition by the user, the store of previous messages comprises a store of previously sent messages, and the step of comparing comprises performing a type-ahead match of content of the new message as the new message is composed to content of a plurality of messages in the previously sent message store, the method further comprising:
presenting the user with a list of match candidate messages chosen by the processing unit from the plurality of messages in the previously sent message store that each has matching content; and
enabling the user to choose one of the presented candidate messages for use in the step of the processing unit automatically completing the composition of the new message by utilizing matching content within the chosen presented candidate message.

3. The method of claim 1, wherein the message input is the new message under composition by the user;
wherein the step of comparing the new message content to the frequently asked question web pages meta data content comprises at least one of:
matching a designated recipient of the new message to web page meta data indicating that the web page content is associated to the designated message recipient;
matching a designated subject matter of the new message to web page meta data indicating that the web page content is associated with the designated subject matter; and
matching message body text of the new message to web page meta data comprising indicating that the web page content comprises common message body text; and
the method further comprising:
presenting a sidebar to the user comprising an initial plurality of the frequently asked question web pages that each match the new message as a function of the matching the designated recipient of the new message to the web page meta data indicating that the web page content is associated to the designated message recipient; and
enabling the user to choose one of the initial plurality of the frequently asked question web pages presented in the sidebar to complete the composition of the new message by utilizing matching content within the chosen frequently asked question web page.

4. The method of claim 3, further comprising:
if the user does not choose one of the initial plurality of the frequently asked question web pages presented in the sidebar to complete the composition of the new message, refining the sidebar to comprise a refined plurality of the frequently asked question web pages that each match the new message as a function of matching the designated recipient of the new message to the web page meta data indicating that the web page content is associated to the designated message recipient, and of at least one of the matching the designated subject matter of the new message to web page meta data and the matching the message body text of the new message to the web page meta data;
presenting the refined sidebar to the user comprising the revised plurality of the frequently asked question web pages; and
enabling the user to choose one of the revised plurality of the frequently asked question web pages presented in the revised sidebar to complete the composition of the new message by utilizing matching content within the chosen frequently asked question web page.

5. The method of claim 1, wherein the message input is the newly received message;
wherein the store of previous messages comprises a store of previously sent messages and a store of previously received messages;
wherein the step of comparing comprises performing a type-ahead match of content of the newly received message to content of a plurality of messages in the previously received message store; and
wherein the step of automatically composing and sending the reply message if the input message meets the requirement of the policy rule comprises composing the reply message to include content of a message of the plurality of messages in the previously received message store that matches content of the newly received message.

6. The method of claim 5, further comprising:
automatically deleting the newly received message as a function of the requirement of the applied policy rule if designated auto-delete content of a message of the plurality of messages in the previously received message store matches content of the newly received message.

7. The method of claim 6, wherein the step of automatically composing and sending the reply message if the input message meets the requirement of the policy rule comprises automatically selecting the matching content, composing the reply message and sending the reply message without requiring active involvement of the user receiving the newly received message, and further comprises:
including a pre-fixed message text in the reply message that informs a sender of the newly received message that the reply message is automated, and informs the sender how to respond if the automated reply message is not satisfactory.

8. The method of claim 1, further comprising:
integrating computer-readable program code into a computer system comprising the processing unit, a computer readable memory and a computer readable tangible storage medium, wherein the computer readable program code is embodied on the computer readable tangible storage medium and comprises instructions that, when executed by the processing unit via the computer readable memory, cause the processing unit to perform the steps of:
comparing the content of the input message to the content saved in the store of previous messages, and to the meta data content of each of the plurality of frequently asked question web pages that are accessible via a network connection, in response to the input of the message;
applying the policy rule to the input message;
automatically composing and sending the reply message;
automatically completing the composition of the input message by utilizing the matching content or providing the link to the matching content, and sending the automatically completed message;
saving the copy of the input message to the store of previous messages;
prompting the user to manually compose and to send the manually composed reply message; and
prompting the user to manually complete the composition of the input message and to send the manually completed message.

9. The method of claim 8, wherein the message input is the new message under composition by the user, the store of previous messages comprises a store of previously sent messages, and the step of comparing comprises performing a type-ahead match of content of the new message as the new message is composed to content of a plurality of messages in the previously sent message store, and the processing unit, when executing the program instructions stored on the tangible computer-readable storage medium via the computer readable memory, further performs steps of:
presenting the user with a list of match candidate messages chosen by the processing unit from the plurality of messages in the previously sent message store that each has matching content; and
enabling the user to choose one of the presented candidate messages for use in the step of automatically completing the composition of the new message by utilizing matching content within the chosen presented candidate message.

10. The method of claim 8, wherein the message input is the new message under composition by the user;
wherein the step of comparing the new message content to the frequently asked question web pages meta data content comprises at least one of:
matching a designated recipient of the new message to web page meta data indicating that the web page content is associated to the designated message recipient;
matching a designated subject matter of the new message to web page meta data indicating that the web page content is associated with the designated subject matter; and
matching message body text of the new message to web page meta data comprising indicating that the web page content comprises common message body text; and
wherein the processing unit, when executing the program instructions stored on the tangible computer-readable storage medium via the computer readable memory, further performs steps of:
presenting a sidebar to the user comprising an initial plurality of the frequently asked question web pages that each match the new message as a function of the matching the designated recipient of the new message to the web page meta data indicating that the web page content is associated to the designated message recipient; and
enabling the user to choose one of the initial plurality of the frequently asked question web pages presented in the sidebar to complete the composition of the new message by utilizing matching content within the chosen frequently asked question web page.

11. The method of claim 10, wherein the processing unit, when executing the program instructions stored on the tangible computer-readable storage medium via the computer readable memory, further performs steps of:
if the user does not choose one of the initial plurality of the frequently asked question web pages presented in the sidebar to complete the composition of the new message, refining the sidebar to comprise a refined plurality of the frequently asked question web pages that each match the new message as a function of matching the designated recipient of the new message to the web page meta data indicating that the web page content is associated to the designated message recipient, and of at least one of the matching the designated subject matter of the new message to web page meta data and the matching the message body text of the new message to the web page meta data;
presenting the refined sidebar to the user comprising the revised plurality of the frequently asked question web pages; and
enabling the user to choose one of the revised plurality of the frequently asked question web pages presented in the revised sidebar to complete the composition of the new message by utilizing matching content within the chosen frequently asked question web page.

12. The method of claim 8, wherein the message input is the newly received message;
wherein the store of previous messages comprises a store of previously sent messages and a store of previously received messages;
wherein the step of comparing comprises performing a type-ahead match of content of the newly received message to content of a plurality of messages in the previously received message store; and
wherein the step of automatically composing and sending the reply message if the input message meets the requirement of the policy rule comprises composing the reply message to include content of a message of the plurality of messages in the previously received message store that matches content of the newly received message.

13. The method of claim 12, wherein the processing unit, when executing the program instructions stored on the tangible computer-readable storage medium via the computer readable memory, further performs the step of automatically composing and sending the reply message if the input message meets the requirement of the policy rule by:
automatically selecting the matching content, composing the reply message and sending the reply message without requiring active involvement of the user receiving the newly received message;
including a pre-fixed message text in the reply message that informs a sender of the newly received message that the reply message is automated, and informs the sender how to respond if the automated reply message is not satisfactory.

14. A system, comprising:
a processing unit in communication with a computer readable memory and a tangible computer-readable storage medium;
wherein the processing unit, when executing program instructions stored on the tangible computer-readable storage medium via the computer readable memory:
in response to an input of a message, compares content of the input message to content saved in a store of previous messages, and to meta data content of each of a plurality of frequently asked question web pages that are accessible to the processing unit via a network connection;
if the compared input message content matches to either of the content saved in the store of previous messages or to the frequently asked question web pages meta data content:
applies a policy rule to the input message;
automatically composes and sends a reply message comprising at least one of the matching content or a link to the matching content, if the input message is a newly received message and meets a requirement of the policy rule; and
automatically completes a composition of the input message by utilizing the matching content or providing the link to the matching content, and sends the automatically completed message, if the input message is a new message under composition by the user and meets the requirement of the policy rule;
if the compared input message content does not match to either of the content saved in the store of previous messages or to the frequently asked question web pages meta data content, or if the input message does not meet the requirement of the policy rule:
saves a copy of the input message to the store of previous messages;
prompts a user to manually compose and to send the manually composed reply message if the input message is the newly received message; and
prompts the user to manually complete the composition of the input message and to send the manually completed message if the input message is the new message under composition by the user.

15. The system of claim 14, wherein the message input is the new message under composition by the user, the store of previous messages comprises a store of previously sent messages, and the processing unit, when executing the program instructions stored on the computer-readable storage medium via the computer readable memory:
compares the input message content by performing a type-ahead match of the content of the new message as the new message is composed to the content of a plurality of messages in the previously sent message store:
presents the user with a list of match candidate messages chosen by the processing unit from the plurality of messages in the previously sent message store that each has matching content; and
enables the user to choose one of the presented candidate messages for use in automatically completing the composition of the new message by utilizing matching content within the chosen presented candidate message.

16. The system of claim 14, wherein the message input is the new message under composition by the user; and
wherein the processing unit, when executing the program instructions stored on the computer-readable storage medium via the computer readable memory, compares the new message content to the frequently asked question web pages meta data content by at least one of:
matching a designated recipient of the new message to web page meta data indicating that the web page content is associated to the designated message recipient;
matching a designated subject matter of the new message to web page meta data indicating that the web page content is associated with the designated subject matter; and
matching message body text of the new message to web page meta data comprising indicating that the web page content comprises common message body text;
presents a sidebar to the user comprising an initial plurality of the frequently asked question web pages that each match the new message as a function of the matching the designated recipient of the new message to the web page meta data indicating that the web page content is associated to the designated message recipient; and
enables the user to choose one of the initial plurality of the frequently asked question web pages presented in the sidebar to complete the composition of the new message by utilizing matching content within the chosen frequently asked question web page.

17. The system of claim 16, wherein the processing unit, when executing the program instructions stored on the computer-readable storage medium via the computer readable memory further:
if the user does not choose one of the initial plurality of the frequently asked question web pages presented in the sidebar to complete the composition of the new message, refines the sidebar to comprise a refined plurality of the frequently asked question web pages that each match the new message as a function of matching the designated recipient of the new message to the web page meta data indicating that the web page content is associated to the designated message recipient, and of at least one of the matching the designated subject matter of the new message to web page meta data and the matching the message body text of the new message to the web page meta data;
presents the refined sidebar to the user comprising the revised plurality of the frequently asked question web pages; and
enables the user to choose one of the revised plurality of the frequently asked question web pages presented in the revised sidebar to complete the composition of the new message by utilizing matching content within the chosen frequently asked question web page.

18. The system of claim 14, wherein the message input is the newly received message;
wherein the store of previous messages comprises a store of previously sent messages and a store of previously received messages; and
wherein the processing unit, when executing the program instructions stored on the computer-readable storage medium via the computer readable memory, performs a type-ahead match of content of the newly received message to content of a plurality of messages in the previously received message store; and
automatically composes and sends the reply message if the input message meets the requirement of the policy rule by composing the reply message to include content of a message of the plurality of messages in the previously received message store that matches content of the newly received message.

19. The system of claim 18, wherein the processing unit, when executing the program instructions stored on the computer-readable storage medium via the computer readable memory:
automatically composes and sends the reply message if the input message meets the requirement of the policy rule by automatically selecting the matching content, composing the reply message and sending the reply message without requiring active involvement of the user receiving the newly received message; and
includes a pre-fixed message text in the reply message that informs a sender of the newly received message that the reply message is automated, and informs the sender how to respond if the automated reply message is not satisfactory.

20. An article of manufacture, comprising:
a computer readable tangible storage medium having computer readable program code embodied therewith, the computer readable program code comprising instructions that, when executed by a computer processing unit, cause the computer processing unit to:
in response to an input of a message, compare content of the input message to content saved in a store of previous messages, and to meta data content of each of a plurality of frequently asked question web pages that are accessible to the processing unit via a network connection;
if the compared input message content matches to either of the content saved in the store of previous messages or to the frequently asked question web pages meta data content:
apply a policy rule to the input message;
automatically compose and send a reply message comprising at least one of the matching content or a link to the matching content, if the input message is a newly received message and meets a requirement of the policy rule; and
automatically complete a composition of the input message by utilizing the matching content or providing the link to the matching content, and send the automatically completed message, if the input message is a new message under composition by the user and meets the requirement of the policy rule;
if the compared input message content does not match to either of the content saved in the store of previous messages or to the frequently asked question web pages meta data content, or if the input message does not meet the requirement of the policy rule:
save a copy of the input message to the store of previous messages;
prompt a user to manually compose and to send the manually composed reply message if the input message is the newly received message; and
prompt the user to manually complete the composition of the input message and to send the manually completed message if the input message is the new message under composition by the user.

21. The article of manufacture of claim 20, wherein the message input is the new message under composition by the user, the store of previous messages comprises a store of previously sent messages, and wherein the computer readable program code instructions, when executed by the computer processing unit, further cause the computer processing unit to:
compare the input message content by performing a type-ahead match of the content of the new message as the new message is composed to the content of a plurality of messages in the previously sent message store:
present the user with a list of match candidate messages chosen by the processing unit from the plurality of messages in the previously sent message store that each has matching content; and
enable the user to choose one of the presented candidate messages for use in automatically completing the composition of the new message by utilizing matching content within the chosen presented candidate message.

22. The article of manufacture of claim 20, wherein the message input is the new message under composition by the user, and wherein the computer readable program code instructions, when executed by the computer processing unit, further cause the computer processing unit to:
compare the new message content to the frequently asked question web pages meta data content by at least one of:
matching a designated recipient of the new message to web page meta data indicating that the web page content is associated to the designated message recipient;
matching a designated subject matter of the new message to web page meta data indicating that the web page content is associated with the designated subject matter; and
matching message body text of the new message to web page meta data comprising indicating that the web page content comprises common message body text;
present a sidebar to the user comprising an initial plurality of the frequently asked question web pages that each match the new message as a function of the matching the designated recipient of the new message to the web page meta data indicating that the web page content is associated to the designated message recipient; and
enable the user to choose one of the initial plurality of the frequently asked question web pages presented in the sidebar to complete the composition of the new message by utilizing matching content within the chosen frequently asked question web page.

23. The article of manufacture of claim 22, wherein the computer readable program code instructions, when executed by the computer processing unit, further cause the computer processing unit to:
if the user does not choose one of the initial plurality of the frequently asked question web pages presented in the sidebar to complete the composition of the new message, refine the sidebar to comprise a refined plurality of the frequently asked question web pages that each match the new message as a function of matching the designated recipient of the new message to the web page meta data indicating that the web page content is associated to the designated message recipient, and of at least one of the matching the designated subject matter of the new message to web page meta data and the matching the message body text of the new message to the web page meta data;
present the refined sidebar to the user comprising the revised plurality of the frequently asked question web pages; and
enable the user to choose one of the revised plurality of the frequently asked question web pages presented in the revised sidebar to complete the composition of the new message by utilizing matching content within the chosen frequently asked question web page.

24. The article of manufacture of claim 20, wherein the message input is the newly received message;
wherein the store of previous messages comprises a store of previously sent messages and a store of previously received messages; and
wherein the computer readable program code instructions, when executed by the computer processing unit, further cause the computer processing unit to:
perform a type-ahead match of content of the newly received message to content of a plurality of messages in the previously received message store; and
automatically compose and send the reply message if the input message meets the requirement of the policy rule by composing the reply message to include content of a message of the plurality of messages in the previously received message store that matches content of the newly received message.

25. The article of manufacture of claim 24, wherein the computer readable program code instructions, when executed by the computer processing unit, further cause the computer processing unit to:
automatically compose and send the reply message if the input message meets the requirement of the policy rule by automatically selecting the matching content, composing the reply message and sending the reply message without requiring active involvement of the user receiving the newly received message; and
include a pre-fixed message text in the reply message that informs a sender of the newly received message that the reply message is automated, and informs the sender how to respond if the automated reply message is not satisfactory.
